(19) United States
(12) Patent Application Publication
(10) Pub. No.: US 2008/0223108 A1
(43) Pub. Date: Sep. 18, 2008

(54) Pipette and sealing mechanism for plunger

(76) Inventors: Masashi Kobayashi, Tokyo (JP); Jun Sasaki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/073,524

(22) Filed: Mar. 6, 2008

(30) Foreign Application Priority Data
Mar. 13, 2007 (JP) 63211/2007
Sep. 12, 2007 (JP) 236972/2007

(51) Int. Cl. G01F 25/00; G01N 1/14

(52) U.S. Cl. 73/1.74; 73/864.18

(57) ABSTRACT

A pipette includes a tubular body (1) having an internal circumferential threaded portion (1b); a stroke screw (5) provided inside the body (1) and having an external circumferential threaded portion (5c) for thread-engaging said internal circumferential threaded portion (1b); a volume variably setting member (4) disposed to be rotatable together with the stroke screw (5) as one unit and axially slidable relative thereto; a central shaft (7) provided inside said tubular body (1), which is coupled to a plunger (29) and operable to be pushed down; and a first-stage spring (10) interposed between an upper portion of said central shaft (7) and said stroke screw (5), which urges the central shaft (7) upward so that a predetermined portion (7b) thereof urgingly abuts against the stroke screw (5), wherein, by rotating said volume variably setting member (4) as appropriate, the stroke screw (5) is caused to rotate together therewith as one unit relative to the body (1) so that said stroke screw (5) and said central shaft (7) axially slide together as one unit apparently by a predetermined amount, thereby variably setting a suction volume of said pipette.

A plunger sealing mechanism includes an O-ring retention ring (101) fitted around said plunger (29); a seal ring (102) fitted around said plunger (29); an O-ring (103) interposed between said O-ring retention ring (101) and said seal ring (102); and an O-ring pressing spring (104) which axially presses said O-ring retention ring (101) with a predetermined force to press said O-ring (103) against an inclined inner surface (121a) of a tubular cylinder member (121) so that said seal ring (102) is radially inwardly pressed against an outer peripheral surface of said plunger (29) by a component of said predetermined force that is in a direction perpendicular to the axis of the pipette, wherein an inclination angle α of said inclined inner surface (121a) is 40° to 65° relative to the direction perpendicular to the axis of the pipette.

### TECHNICAL FIELD OF THE INVENTION

The present invention relates to a pipette whose suction and discharge volume is variably settable and a sealing mechanism for a plunger used in the pipette.

### BACKGROUND OF THE INVENTION

An example of a conventional variable pipette is composed of a resin-made substantially tubular body or pipette body (with a sampling chamber, i.e., cylinder chamber at its lower end), a metal sheath having an external circumferential thread which threadingly engages an internal circumferential thread of the pipette body, a central push rod of a hexagonal shape in cross section which is unrotatably and axially slidably inserted in a central hexagonal hole of the metal sheath, and a piston rod and a piston integral therewith which, at a position below the push rod, are urged upwardly into abutment against the lower end of the push rod by first and second coil springs (hereinafter referred to as a first-stage spring and a second-stage spring), all of which are disposed in a coaxial manner.

In the above construction, the push rod is pushed down against the first-stage spring together with the piston as one unit to reciprocally slide in a downward direction by a first-stage stroke l₁, so that a sample is sucked into a disposable nozzle (tip) attached to the lower end of the pipette body. Then, pushing-down again of the push rod through the distance l₁ allows the sample to be discharged. On further pushing down, the push rod slides downward through the second-stage stroke l₂ against the second-stage spring in addition to the first-stage spring, so that due to this second-stage discharge, any sample remaining inside the tip is completely discharged.

Next, to variably set the suction volume of a sample, the metal sheath is rotated in a predetermined direction, whereby the metal sheath moves upward or downward by a predetermined amount through a thread engagement between the external circumferential thread of the metal sheath and the internal circumferential thread of the pipette body, thus enabling the vertical stroke of movement of the piston to be adjusted in the increasing or decreasing direction.

Concurrently with the variable setting of the suction volume through the rotation of the metal sheath in a predetermined direction, a numerical indicator of the suction volume is driven in an interlocked manner so as to indicate the numerical value of the variably-set suction volume.

(1) However, according to the construction of the above conventional example, since the first-stage spring is provided below the central push rod, when the central push rod is moved, for example, downward at the time of variably setting the suction volume by the metal sheath, the piston rod also moves in the same direction so as to compress the first-stage spring by that distance of movement. Consequently, there has been a drawback that the load of the first-stage spring becomes gradually greater as the suction volume is variably set, for example, in a decreasing direction, resulting in a need of heavy operation of the central push rod.

(2) Furthermore, the initial length of the first-stage spring per se or its initial load (i.e., the heaviness feeling at the time of pushing down the push rod) has not been able to be variably set.

(3) Furthermore, there has been a problem that, since the tip attached portion at the lower end of the pipette body to which a tip is attached is merely made of resin, multiple repetition of attachment and detachment of a tip has caused a wear of the tip attached position. In addition, since the outer periphery of the tip attached portion at the lower end of the pipette body is merely of cylindrical shape, a tip, when snugly fitted thereon, intimately contacts the tip attached portion with a large fitting force. Accordingly, the load becomes relatively large when manually ejecting the tip with an ejector mechanism, resulting in difficulty in operation.

(4) There has been a problem that the pipette, which is made of resin, allows the heat of a hand to be conducted to the inside of the pipette when the pipette body is held in a hand for a long period of time, thus causing unstable fluctuations in the suction volume.

(5) Tips are provided in various types of dimensions, and thus the spacing between the lower end of the ejector pipe and the tip may change in size variously. Consequently, there have been cases where, due to the large size of this spacing, a tip is unsuccessfully ejected even if the ejector mechanism is actuated and the ejector pipe is lowered.

(6) If an indication of a numerical value of the suction volume of the suction volume indicating mechanism deviates from the actual suction volume of the sample, a so-called calibration is performed to make a change of the numerical indication of the suction volume. There has been a problem that, to this end, it is needed either to remove the indicating mechanism as a unitary structure once from the pipette for calibrating and correcting the numerical indication and reassemble the same to the pipette, or to make use of a special-purpose jig for the calibration.

(7) Moreover, in a plunger sealing mechanism in which an O-ring is provided inside the tubular body, between a plunger (piston rod) which vertically moves together with a central shaft (central push rod) and a tubular cylinder member in which the plunger is slidably fitted, that provides a seal around the plunger outer peripheral surface, the O-ring is pressed against an inclined surface of the tubular cylinder member by a spring. The inclined angle β of this inclined surface, however, has been comparatively small, amounting to approximately 5° relative to the direction that is perpendicular to the axis of the pipette (β=5°; see FIGS. 25, 31 and 32).

Thus, as will be apparent from FIG. 32, when the spring force P with which to axially press the O-ring (not shown) is assumed to be 307.6 g, the same as in the later-described present invention, its decomposed forces q and r become 308.78 g and 26.91 g, respectively. The component r (26.91 g) in the direction perpendicular to the axis of the pipette in particular is extremely small, meaning that the force with which the O-ring radially inwardly presses against the plunger, i.e., the sealing force is small. Hence, if a wear occurs in the sliding portions as a result of repeated use, a hermeticity may be lost at a comparatively early stage, possibly resulting in a liquid leakage therethrough and a reduction in the dispensing accuracy of the pipette.

### SUMMARY OF THE INVENTION

(1) Therefore, an object of the present invention is to provide a pipette in which a first-stage spring (10) is disposed not below a stroke screw (5), but above the stroke screw, between a push button (6) and the stroke screw (5). Consequently, during the variably setting operation of the suction volume, the first-stage spring (10) moves vertically with the entire length of the spring per se maintained constant. Thus, the load of the first-stage spring (10) once set at the initial stage remains constant during the above movement, so that the drawback as in the conventional example is precluded which causes the first-stage spring to be compressed and increased in load, resulting in a heavy button operation. Therefore, the button operation of the present invention remains unchangingly light.

(2) Another object of the present invention is to provide a pipette in which the initial length of the first-stage spring (10) per se or its initial load (the heaviness feeling at the time of pushing down the central shaft (10)) is variably settable. To this end, a first-stage spring load varying pipe (8) is rotated to allow a first-stage spring extension setting plate (9) to axially move, through thread engagement between an internal circumferential thread (8a) of the pipe (8) and an external circumferential thread (9a) of the first-stage spring extension setting plate (9), to thereby shorten or lengthen the first-stage spring (10) to variably set an initial load of the first-stage spring (10). This allows the feeling (heaviness) when pushing down the push button (6) to be conveniently adjusted.

(3) Yet another object of the present invention is to provide a pipette in which a nozzle tip (24) for attachment thereto of a tip (46) is made of ceramic. Thus, since ceramic has a high wear resistance, and is highly durable, it gives rise to little wear upon repeated attachment and detachment of a tip (46). Furthermore, the nozzle tip (24) has, for example, an axially undulated uneven portion (24a) formed on its outer peripheral surface. As a result, the frictional load between the nozzle tip (24) and the tip (46) is small, and thus the load at the time of ejecting the tip (46) is small, leading to an easy ejecting operation.

Please note that the uneven portion (24a) is not limited to an axially undulated one, but may be undulated in a radial or any other direction insofar as it is in an uneven form.

Furthermore, an expandable layer (36) of rubber or elastomer (see FIG. 23) is in advance first insert-molded in an outer circumferential groove (24c) on a to-be-insert-molded portion (24b) of the nozzle tip (24) to the tubular cylinder (21) (or tubular body (1)), and thereafter this portion is second insert-molded to the tubular cylinder (21). This allows a strong assembling force to be maintained between the tubular cylinder (21) and the nozzle tip (24), since the expandable layer (36) absorbs a clearance that may be produced between them by a difference in their thermal expansions during the heating of the pipette in an autoclave treatment.

(4) Still another object of the present invention is to provide a pipette in which the tubular body (1) is formed from a finely foamed molded material such as polyphenyl sulfone. This makes the body (1) resistant to a conduction of the heat of a hand therethrough when grasped by the hand so that fluctuations in the suction volume that may result from the influence of the hand heat are very small.

(5) A still further object of the present invention is to provide a pipette in which a first engagement portion provided on either an upper ejector pipe (41) or a lower ejector pipe (42) is engageable in a switchable manner with any one of a plurality of second engagement portions provided on the other so that the lower end position of the lower ejector pipe (42) may be varied. Accordingly, if tips (46) of various standardized sizes are attached on the outer periphery of the nozzle tip (24), the lower end position of the lower ejector pipe (42) can be adjusted in accordance therewith, thereby enabling a smooth ejecting operation and widening the applicability of the pipette.

(6) Still another object of the present invention is to provide a pipette in which a volume variably setting and calibration pipe (4) is forcibly moved in an axial direction to disengage a clutch claw (4b) of the calibration pipe (4) from a meshing gear portion (3a) of the clutch pipe (3), and then rotating the calibration pipe (4) to drive a counter mechanism (51) without varying the actual suction volume to thereby vary only an indication of a numerical value of the suction volume to perform the calibration. This allows the calibration to be performed easily without the need for a special-purpose jig or the like for the calibration.

(7) Still another object of the present invention is to provide a plunger sealing mechanism for a pipette which has an improved sealing performance. An O-ring (103) is pressed against an inclined inner surface (121a) of a tubular cylinder (121) by an O-ring pressing spring (104) with a predetermined force so that a component of the predetermined force that is in a direction perpendicular to the axis of the pipette (radially inwardly directed force) causes a seal ring (102) to be pressed against the outer peripheral surface of the plunger (29). Moreover, the inclined angle (α) of the above inclined inner surface (121a) is set at from 40° to 65° relative to the direction perpendicular to the axis of the pipette. Consequently, the above plunger pressing force is increased over the conventional case where the inclined angle is approximately 5° (see R; FIGS. 31 and 32), so as to provide an improved sealing performance. Additionally, by selecting a suitable wear-resistant material for the above seal ring (102), the service life of the seal ring (102) can be lengthened.

(8) A still another object of the present invention is to provide a plunger sealing mechanism for a pipette in which the inclined angle (α) of the above inclined inner surface (121a) is set at 50° relative to the direction perpendicular to the axis of the pipette to obtain a maximum sealing performance and a maximum sealing life while maintaining a smooth sliding operation of the plunger (29).

(9) A still further object of the present invention is to provide a plunger sealing mechanism for a pipette in which the seal ring (102) has one or more circumferential grooves (102c) formed on its inner peripheral surface which fits around the outer peripheral surface of the plunger (29). Consequently, in the first place, although the frictional resistance force of the plunger (29) to sliding tends to become greater with the increase in the above predetermined force (axial force), the inner circumferential grooves (102c) reduce the area of contact between these fitting surfaces and suppress a rise in the frictional resistance force to the sliding. Secondly, if a wear occurs in the sealing portion (102a) and the plunger (29) due to the frictional sliding and wear powder is produced, the inner circumferential grooves (102c) receive the wear powder therein and prevent a further progress of wear which would otherwise take place by the abrading effect of the wear powder on the sliding surfaces.

A first construction of the present invention for attaining an object above is characterized by a pipette which comprises: a tubular body (1) having a first threaded portion (1b); a stroke screw (5) provided inside the body (1) and having a second threaded portion (5c), said second threaded portion threadingly engaging said first threaded portion (1b); a volume variably setting member (4) disposed to be rotatable together with the stroke screw (5) as one unit and axially slidable relative thereto; a central shaft (7) provided inside said tubular body (1), which is coupled to a plunger (29) and operable to be pushed down; and a first-stage spring (10) interposed between an upper portion of said central shaft (7) and said stroke screw (5), said first-stage spring urging the central shaft (7) upward so that a predetermined portion (7b) thereof urgingly abuts against the stroke screw (5), wherein, by rotating said volume variably setting member (4) as appropriate, the stroke screw (5) is caused to rotate together therewith as one unit relative to the body (1) so that said stroke screw (5) and said central shaft (7) axially slide together as one unit apparently by a predetermined amount, thereby variably setting a suction volume of said pipette.

Another construction of the present invention is characterized by a pipette which comprises: a substantially tubular body (1) having a first threaded portion (1b); a stroke screw (5) provided inside the body (1) and having a second threaded portion (5c), said second threaded portion threadingly engaging said first threaded portion (1b); a clutch member (3) having a first engagement portion (3a) and disposed to be rotatable together with the stroke screw (5) as one unit and axially slidable relative thereto; a volume variably setting member (4) having a second engagement portion (4b) and disposed to be rotatable together with the clutch member (3) as one unit when said first and second engagement portions (3a, 4a) are in engagement with each other; a central shaft (7) provided inside said tubular body (1), which is coupled to a plunger (29) and operable to be pushed down; and a first-stage spring (10) interposed between an upper portion of said central shaft (7) and said stroke screw (5), said first-stage spring urging the central shaft (7) upward so that a predetermined portion (7b) thereof urgingly abuts against the stroke screw (5), wherein, by rotating said volume variably setting member (4) as appropriate, the stroke screw (5) is caused to rotate together therewith as one unit relative to the body (1) so that said stroke screw (5) and said central shaft (7) axially slide together as one unit apparently by a predetermined amount, thereby variably setting a suction volume of said pipette.

Yet another construction of the present invention is characterized by a pipette which comprises: a substantially tubular body (1) having a first threaded portion (1b); a stroke screw (5) provided inside the body (1) and having a second threaded portion (5c), said second threaded portion threadingly engaging said first threaded portion (1b); a central shaft (7) provided inside said tubular body (1), which is coupled to a plunger (29) and operable to be pushed down; a first-stage spring load varying member (8) having a third threaded portion (8a) and provided at an upper portion of said central shaft (7) to be rotatable relative thereto; a first-stage spring extension setting member (9) having a fourth threaded portion (9a) which threadingly engages said third threaded portion (8a), and provided at the upper portion of said central shaft (7) to be unrotatable and axially slidable relative thereto; and a first-stage spring (10) interposed between the upper portion of said central shaft (7) and said stroke screw (5), said first-stage spring urging said central shaft (7) upward so that a predetermined portion (7b) thereof urgingly abuts against the stroke screw (5), wherein, by rotating said first-stage spring load varying member (8) as appropriate, said first-stage spring extension setting member (9) is caused to axially slide relative to the body (1), thereby variably setting an entire extension length of said first-stage spring (10).

Yet another construction of the present invention is characterized by a pipette which has a tubular housing (1 or 21) made of resin, wherein a nozzle tip (24) made of ceramic is integrally insert-molded at a distal end portion of said tubular housing (1 or 21).

Preferably, the said nozzle tip (24) made of ceramic has an expandable layer (36) of rubber or elastomer insert-molded at a predetermined portion (24c) thereof prior to its insert-molding to said tubular housing (1 or 21).

Preferably, the said nozzle tip (24) made of ceramic has an uneven portion (24a) formed on an outer periphery thereof.

Yet another construction of the present invention is characterized by a pipette which has a tubular body (1), wherein material for said tubular body (1) is finely foamed molded material.

Preferably, the said finely foamed molded material is polyphenyl sulfone.

Yet another construction of the present invention is characterized by a pipette which has an ejector mechanism for a tip, wherein said ejector mechanism (32) includes at least an ejector button (33), an upper ejector pipe (41), and a lower ejector pipe (42) which pushes a tip (46), and wherein a first engagement portion (41a) provided on either one of said upper ejector pipe (41) or said lower ejector pipe (42) is switchably engageable with any of a plurality of second engagement portions (42c, 42d, 42e) provided on the other so that a distal end position of said lower ejector pipe (42) is varied.

Yet another construction of the present invention is characterized by a pipette which comprises: a tubular body (1); a stroke screw (5) provided inside said body (1), which variably sets a suction volume of the pipette; a clutch member (3) having a first engagement portion (3a) and disposed to be rotatable together with the stroke screw (5) as one unit and axially slidable relative thereto; a calibration member (4) having a second engagement portion (4b) and disposed to be axially slidable relative to the clutch member (3) and rotatable together therewith as one unit only when the first and second engagement portions (3a, 4b) are engaged with each other; a central shaft (7) provided inside said tubular body (1), which is coupled to a plunger (29) and operable to be pushed down; and a suction volume indicating counter mechanism (51) which is capable of interlocking with said calibration member (4), wherein, by axially sliding said calibration member (4) to release engagement of said first and second engagement portions (3a, 4b), and rotating said calibration member (4) in this state as appropriate, only said counter mechanism (51) is operated without causing any rotation of said stroke screw (5) so as to perform a calibration of an indication of a numerical value of the suction volume.

Additionally, another construction of the present invention for attaining an object above is characterized by, in a pipette in which a central shaft (7) is provided inside a tubular body (1) to be vertically slidable together with a plunger (29) as one unit and is adapted to be pushed down against at least a first-stage spring (10), a plunger sealing mechanism for the pipette which is provided between said plunger (29) and a tubular cylinder member (121) in which said plunger (29) is slidably fitted, said plunger sealing mechanism comprising: an O-ring retention ring (101) fitted around said plunger (29); a seal ring (102) fitted around said plunger (29); an O-ring (103) interposed between said O-ring retention ring (101) and said seal ring (102); and an O-ring pressing spring (104) which axially presses said O-ring retention ring (101) with a predetermined force to press said O-ring (103) against an inclined inner surface (121a) of said tubular cylinder member (121) so that said seal ring (102) is radially inwardly pressed against an outer peripheral surface of said plunger (29) by a component of said predetermined force that is in a direction perpendicular to the axis of the pipette, wherein an inclination angle α of said inclined inner surface (121a) is 40° to 65° relative to the direction perpendicular to the axis of the pipette.

Preferably, the said inclination angle α of said inclined inner surface (121a) is 50° relative to the direction perpendicular to the axis of the pipette.

Preferably, the said seal ring (102) has one or more circumferential grooves (102c) on an inner peripheral surface of a sealing portion (102a) thereof which fits around the outer peripheral surface of said plunger (29).

### BRIEF DESCRIPTION OF THE DRAWINGS

FIG. 1A is an enlarged longitudinal sectional view of an upper half of a pipette according to a first embodiment of the present invention.

FIG. 1B is an enlarged longitudinal sectional view of a lower half of the pipette according to the first embodiment of the present invention.

FIG. 2 is a longitudinal sectional view of the upper half of the pipette of FIG. 1 in a state upon completion of a first-stage pushing down.

FIG. 3 is a longitudinal sectional view of the upper half of the pipette of FIG. 1 in a state upon completion of a second-stage pushing down.

FIG. 4A is a perspective view of a tubular body.

FIG. 4B is a longitudinal sectional view of the tubular body.

FIG. 5A is a perspective view of a central partition wall.

FIG. 5B is a plan view of the central partition wall.

FIG. 6A is a perspective view of a clutch pipe.

FIG. 6B is a plan view of the clutch pipe.

FIG. 7A is a perspective view of a volume variably setting and calibration pipe.

FIG. 7B is a longitudinal sectional view of the volume variably setting and calibration pipe.

FIG. 7C is an underside view of the volume variably setting and calibration pipe.

FIG. 8A is a perspective view of a stroke screw.

FIG. 8B is a longitudinal sectional view of the stroke screw.

FIG. 9A is a perspective view of a push button.

FIG. 9B is an underside view of the push button.

FIG. 10A is a side view of a central shaft.

FIG. 10B is an underside view of the central shaft.

FIG. 11 is a perspective view of a first-stage spring load varying pipe.

FIG. 12A is a perspective view of a first-stage spring extension setting plate.

FIG. 12B is a plan view of the first-stage spring extension setting plate.

FIG. 13 is a longitudinal sectional view of a tubular cylinder.

FIG. 14A is a perspective view of a tubular seal holder.

FIG. 14B is a longitudinal sectional view of the tubular seal holder.

FIG. 15A is a perspective view of a nozzle tip.

FIG. 15B is a longitudinal sectional view of the nozzle tip.

FIG. 16A is a perspective view of a plunger head.

FIG. 16B is a longitudinal sectional view of the plunger head.

FIG. 17 is a plan view of a second-stage spring holder.

FIG. 18 is a side view of a plunger.

FIG. 19A is a perspective view of an upper ejector pipe.

FIG. 19B is a longitudinal sectional view of the upper ejector pipe.

FIG. 20A is a perspective view of a lower ejector pipe.

FIG. 20B is a side view of the lower ejector pipe.

FIG. 20C is a longitudinal sectional view of the lower ejector pipe.

FIG. 21 is an exploded perspective view of a counter mechanism.

FIG. 22A is a perspective view of a counter plate.

FIG. 22B is an underside view of the counter plate.

FIG. 23 is a partial enlarged sectional view of a mounting portion for a nozzle tip.

FIG. 24 is an enlarged longitudinal sectional view of an upper half of a pipette according to a second embodiment of the present invention.

FIG. 25 is an enlarged longitudinal sectional view of an essential portion of the pipette of FIG. 24.

FIG. 26 is a longitudinal sectional view of a tubular cylinder of the pipette in FIG. 24.

FIG. 27A is a perspective view of a tubular seal holder of the pipette in FIG. 24.

FIG. 27B is a longitudinal sectional view of the tubular seal holder.

FIG. 28A is a front view of an O-ring retention ring of the pipette in FIG. 24.

FIG. 28B is a longitudinal sectional view of the O-ring retention ring.

FIG. 29A is a front view of an O-ring receiving seal ring of the pipette in FIG. 24.

FIG. 29B is a longitudinal sectional view of the O-ring receiving seal ring.

FIG. 30A is a front view of an O-ring of the pipette in FIG. 24.

FIG. 30B is a longitudinal sectional view of the O-ring.

FIG. 31 is a view showing the relation of the action of force of each portion of FIG. 25.

FIG. 32 is a view showing vectors of the forces.

### BEST MODE FOR CARRYING OUT THE INVENTION

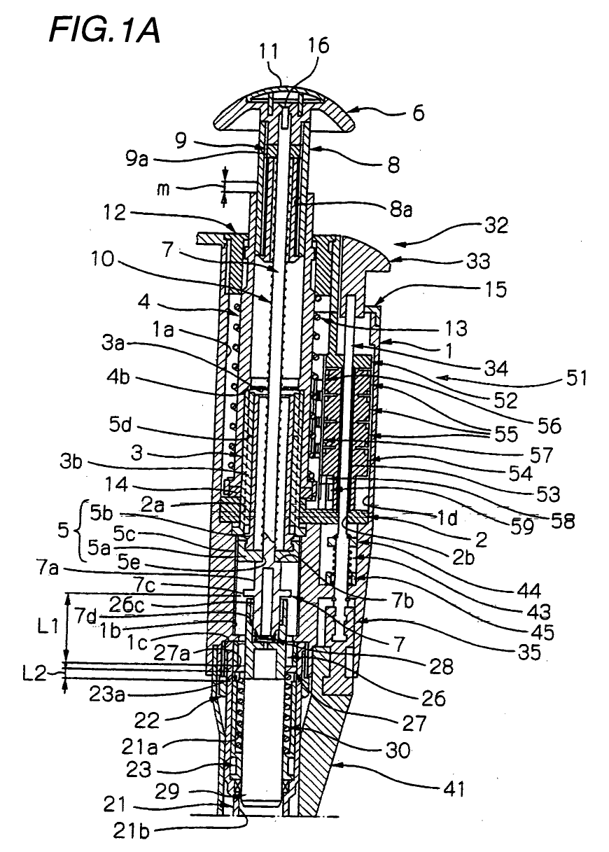

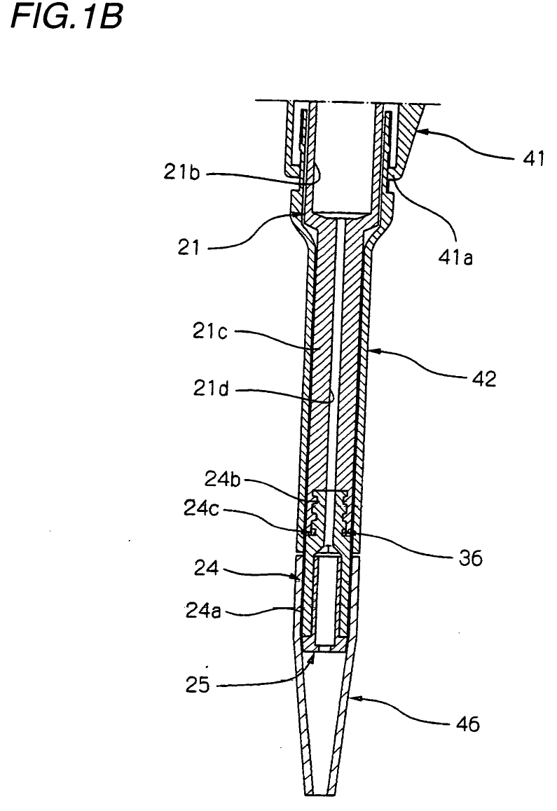

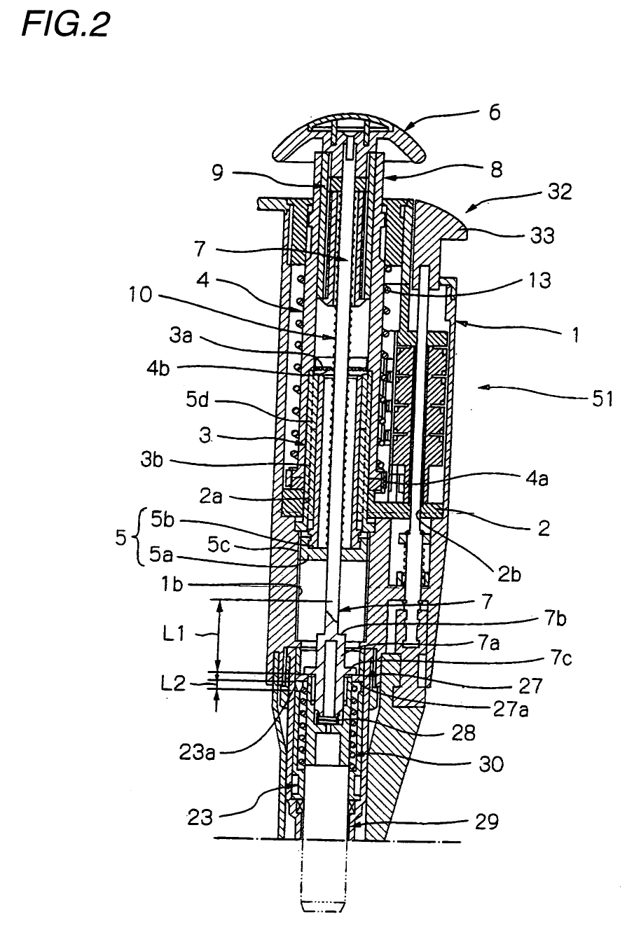

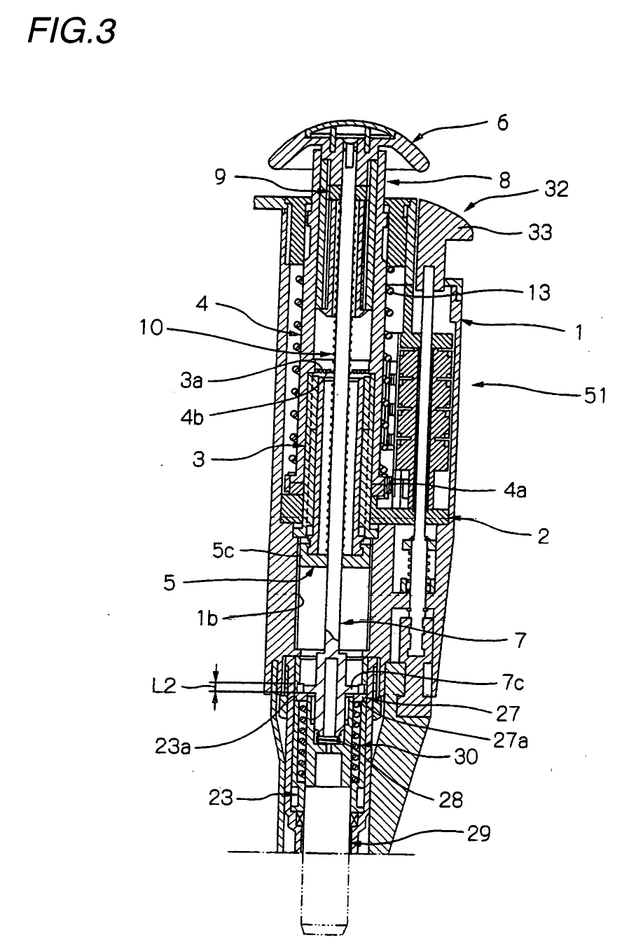

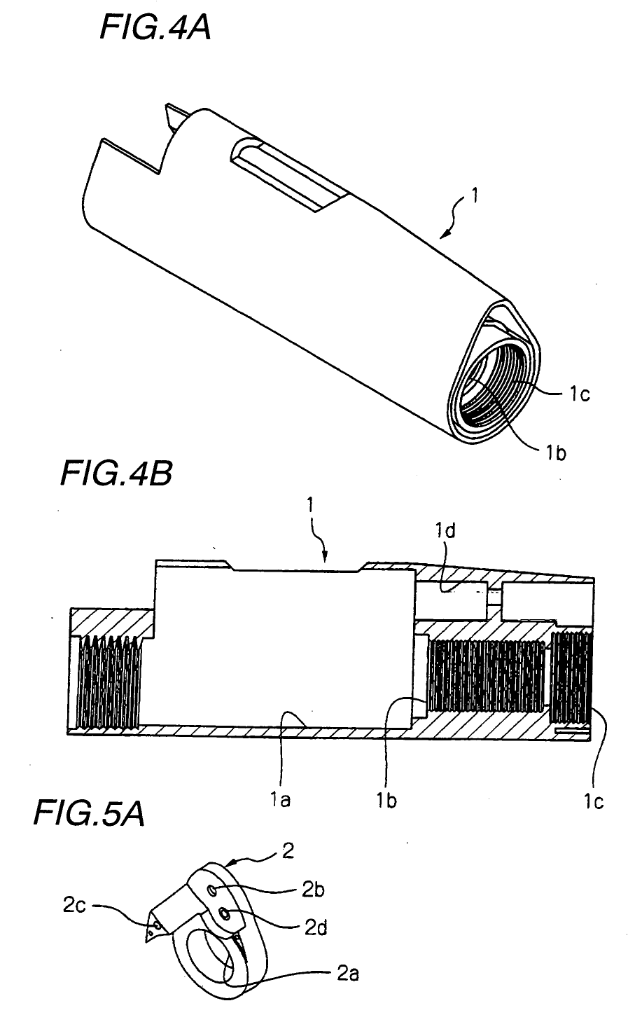

FIG. 1A is an enlarged longitudinal sectional view of an upper half of a pipette according to a first embodiment of the present invention. FIG. 1B is an enlarged longitudinal sectional view of a lower half of the same. FIGS. 2 and 3 are longitudinal sectional views of the pipette in states upon completion of a first-stage pushing down and of a second-stage pushing down, respectively. Please note that, regarding FIG. 4 and thereafter, the left side in the figures basically corresponds to the upper side in FIGS. 1 to 3, and the right side in the figures corresponds to the lower side in FIGS. 1 to 3.

In FIGS. 1 and 4, 1 denotes a tubular body of a variable pipette according to the present invention, which has threaded holes 1b and 1c coaxially provided with a central hole 1a, and an ejector shaft hole 1d. Since this tubular body 1 is formed from a finely foamed molded material such as, for example, polyphenyl sulfone, the heat of a hand, when the body 1 is grasped by the hand, is difficult to be conducted to the inside of the pipette. Thus, fluctuations in the suction volume by the influence of the hand heat are very small.

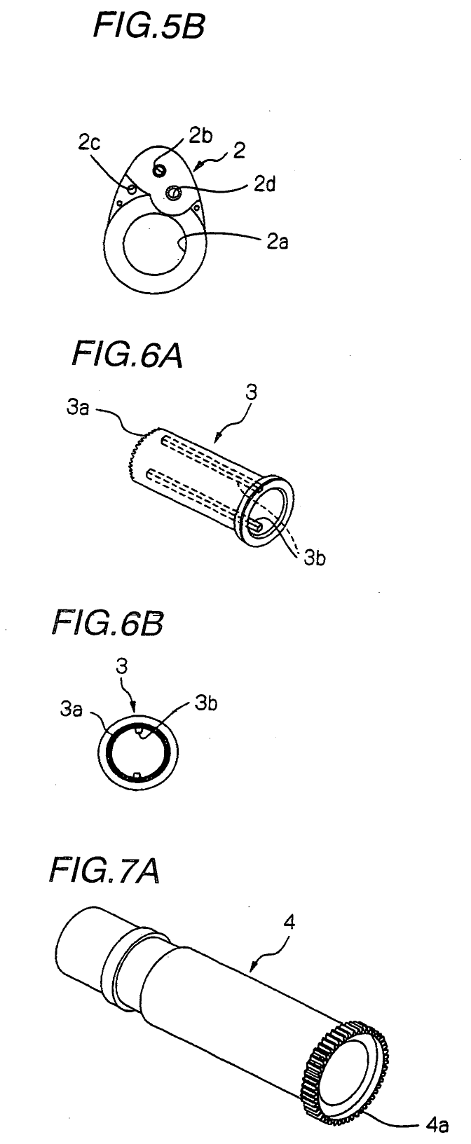

2 denotes a central partition wall, which, in FIGS. 1 and 5, is inserted and fitted in the central hole 1a of the tubular body 1, and has a central through-hole 2a and other through-holes 2b to 2d.

3 denotes a tubular clutch pipe, which, in FIGS. 1 and 6, is passed through the central through-hole 2a of the central partition wall 2 and, as shown in FIG. 6, has a meshing gear portion 3a at the left end (upper end), and a pair of axially-extending guide projections 3b on the inner periphery.

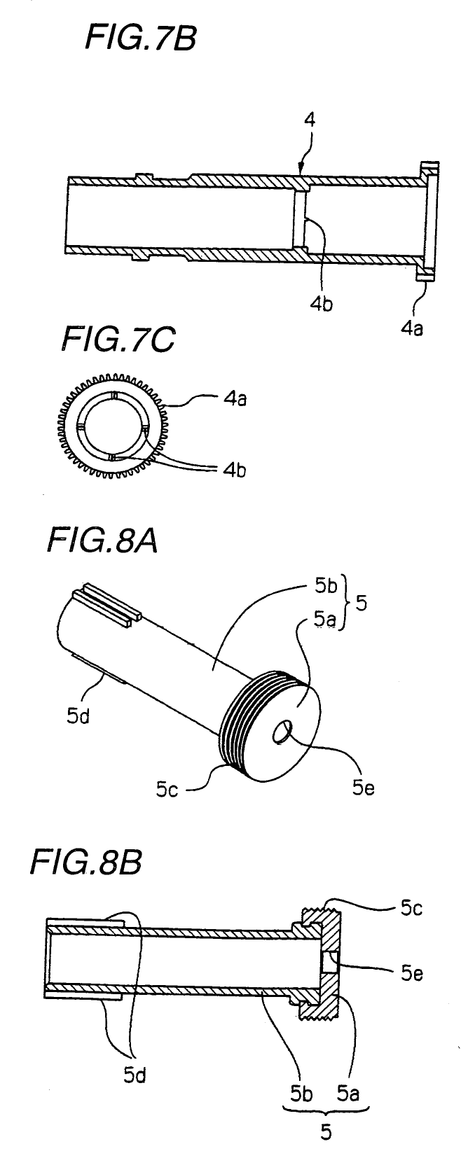

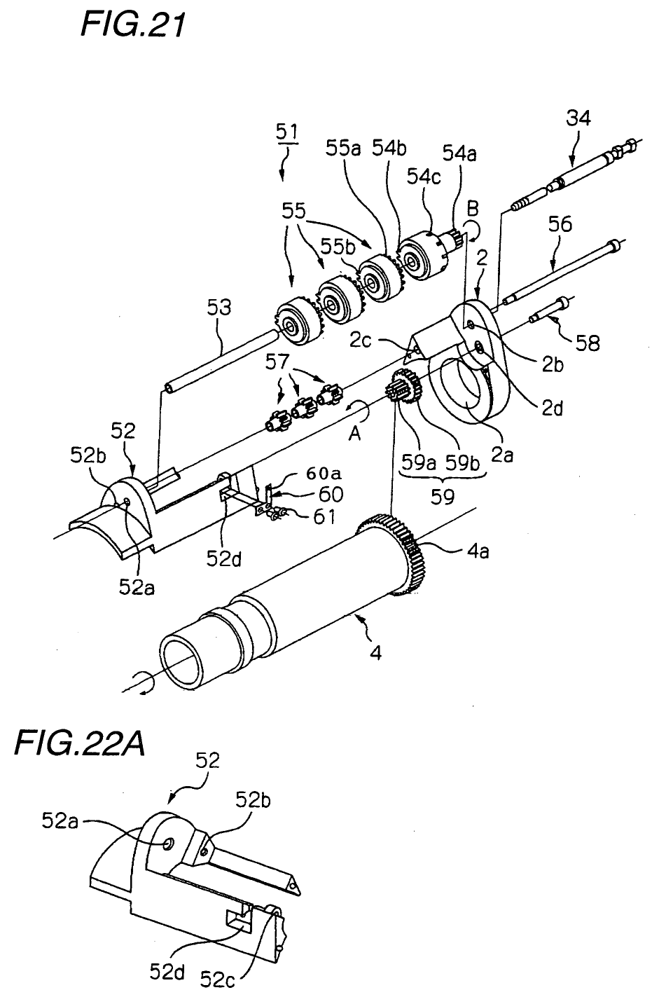

4 denotes a volume variably setting and calibration pipe, which in FIG. 1 is fitted over the outer periphery of the clutch pipe 3 and, as shown in FIG. 7, has an outer circumferential gear portion 4a at the right end (lower end) and clutch claws 4b on the inner periphery at four circumferentially equally spaced positions at an axial predetermined position. (The clutch claws are capable of meshing with the above meshing gear portion 3a of the clutch pipe 3). This volume variably setting and calibration pipe 4 is urged downward in FIG. 1 by a pipe holding spring 13 which is interposed between the outer circumferential gear portion 4a and a body lock 12 screwed into the left end (upper end) of the tubular body 1, so as to abut against a slip ring 14. In this state, its outer circumferential gear portion 4a meshes with a later-described pinion portion 59a of a transmission gear 59 (see FIG. 21), while at the same time the clutch claws 4b mesh with the meshing gear portion 3a of the clutch pipe 3.

5 denotes a stroke screw which, in FIGS. 1 and 8, is integrally formed of a stroke screw flange portion 5a and a stroke screw tubular portion 5b, and is inserted inside the inner periphery of the clutch pipe 3. At this time, an external circumferential thread 5c on the flange portion 5a threadingly engages the threaded hole 1b of the tubular body 1, and axially-extending guide recesses 5d on the tubular portion 5b engage the guide projections 3b of the clutch pipe 3.

Consequently, if the volume variably setting and calibration pipe 4 is rotated, for example, in a clockwise direction as viewed from above, the clutch pipe 3 rotates in the same direction together therewith as one unit through engagement between the clutch claws 4b and the meshing gear portion 3a, which in turn causes the stroke screw 5 to integrally rotate in the same direction through engagement between the guide recesses 5d and the guide projections 3b. As a result, the stroke screw 5 (and later described central shaft 7 and plunger 29) moves downward in FIG. 1 through the thread engagement between the threaded portions 5c and 1b, so as to make smaller the first-stage stroke L1, i.e., variably set the suction volume of a cylinder chamber 21b in a decreasing direction. Reverse rotation of the volume variably setting and calibration pipe 4 in a counterclockwise direction variably sets the suction volume in an increasing direction. Please note that, at the time of variably setting the suction volume through rotation of the volume variably setting and calibration pipe 4, a later-described counter mechanism 51 concurrently variably indicates a numerical value corresponding to the above variably set volume through engagement between the outer circumferential gear portion 4a and the pinion portion 59a of the transmission gear 59 (see FIG. 21).

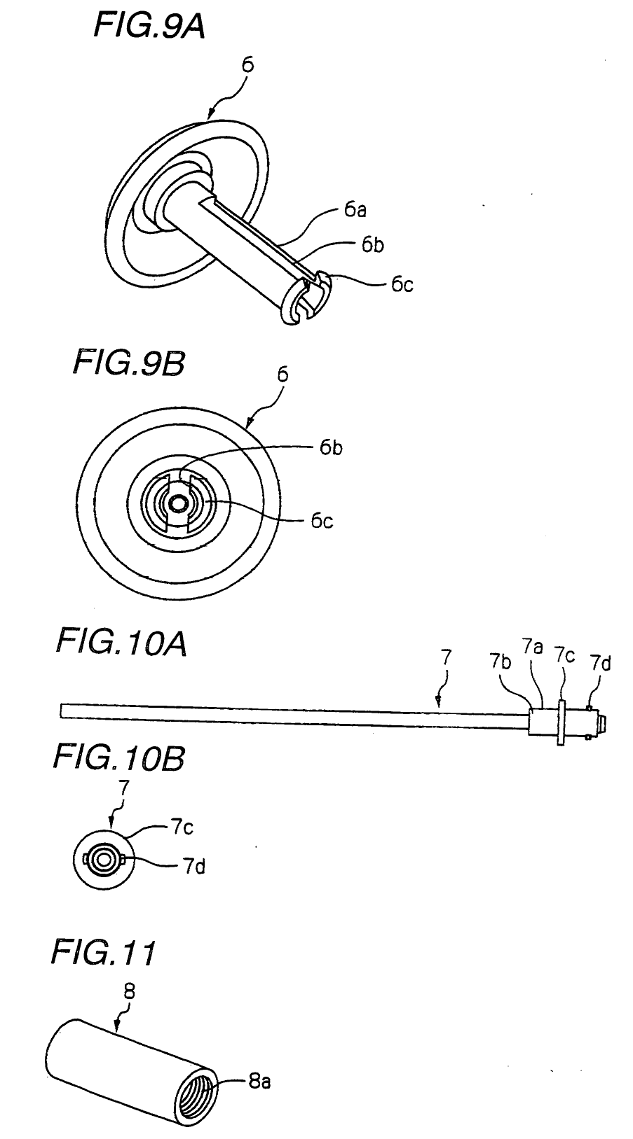

6 denotes a push button which, as shown in FIG. 9, has a tubular portion 6a, a pair of axially-extending guide slits 6b and a tip claw portion 6c, and is coaxially fixed to the central shaft 7 with a screw 16 (see FIG. 1). The central shaft 7, as shown in FIG. 10, has an enlarged diameter portion 7a at the right end (lower end), a stopper step portion 7b thereof, a flange portion 7c, and a pair of protrusions 7d. The push button 6 is inserted in the volume variably setting and calibration pipe 4, and the central shaft 7 passes through the central hole 5e of the stroke screw 5 to be positioned.

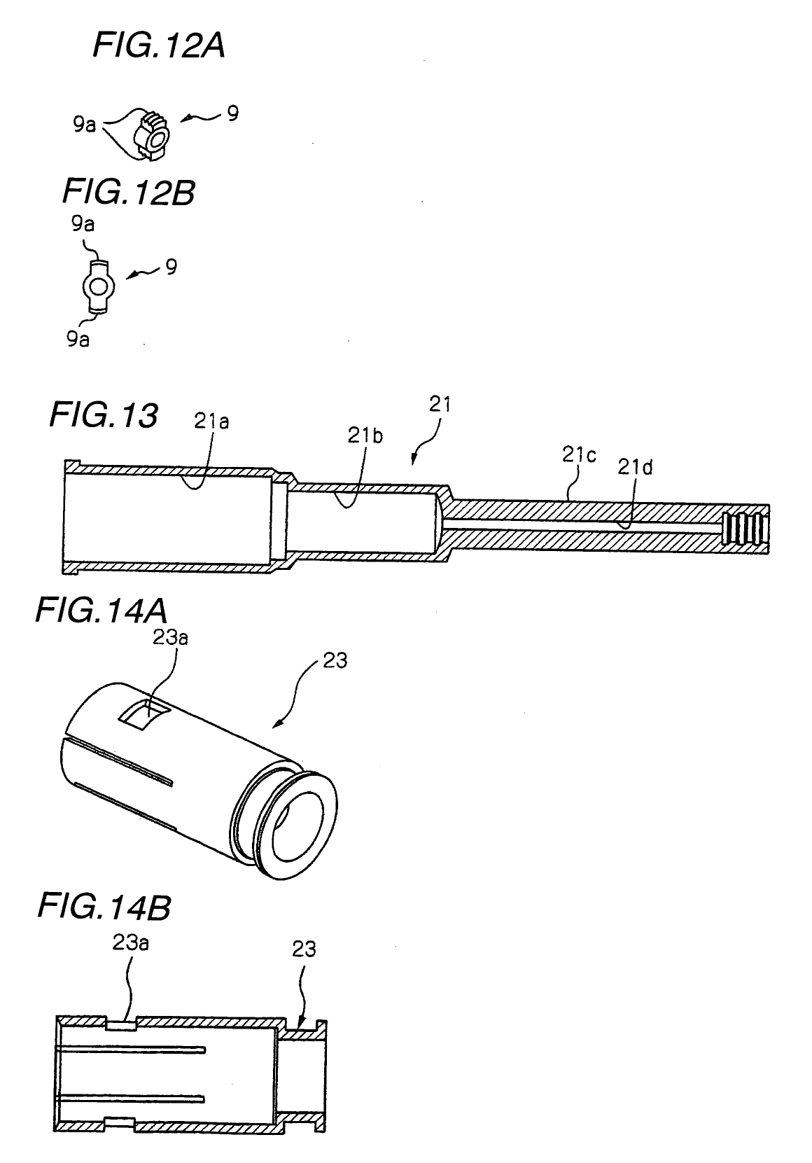

8 denotes a first-stage spring load varying pipe which, as shown in FIG. 11, has an internal circumferential thread 8a and is fitted over the outer periphery of the tubular portion 6a of the push button 6 and locked by the tip claw portion 6c. 9 designates a first-stage spring extension setting plate of substantially “I” shape which, as shown in FIG. 12, has a pair of external circumferential threads 9a, and which, in the state of being fitted on the central shaft 7, is inserted and engaged in the pair of axially-extending guide slits 6b of the push button 6 so that its external circumferential threads 9a threadingly engage the internal circumferential thread 8a of the first-stage spring load varying pipe 8. 10 designates a first-stage spring which, in FIG. 1, is fitted around the outer periphery of the central shaft 7. 11 designates a button cover, and 15 a lid body.

Hence, the push button 6 and the central shaft 7 are urged upward in FIG. 1 by the first-stage spring 10 so that a large-diameter stopper step portion 7b of the central shaft 7 abuts against the flange portion 5a of the stroke screw 5.

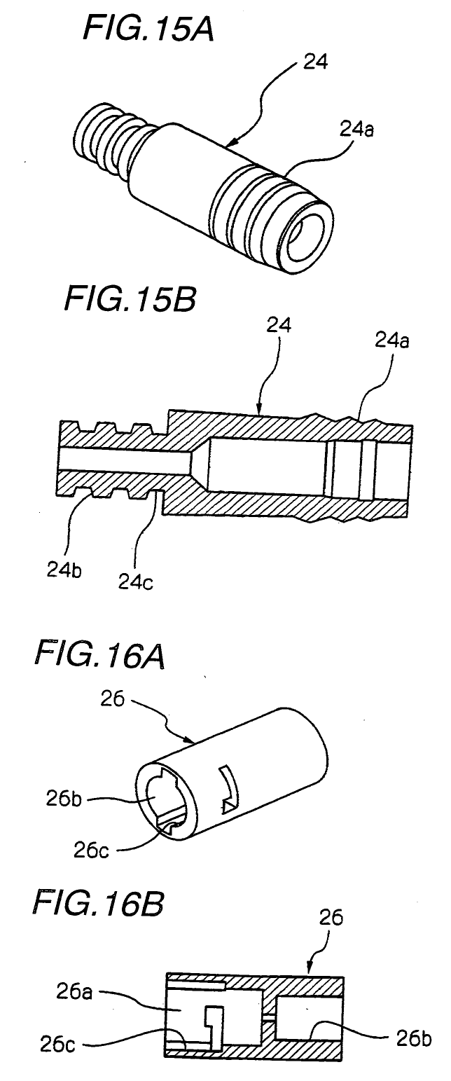

Next, 21 denotes a tubular cylinder made of resin which, as shown in FIG. 13, has a large-diameter portion 21a, a cylinder chamber 21b, and a passage 21d in a nozzle portion 21c in succession from the left, and has a nozzle tip 24 integrally insert-molded at the right end (lower end). This tubular cylinder 21 is inserted in the threaded hole 1c at the lower end (right end) of the tubular body 1 and fixed with a lock nut 22 (see FIG. 1). 23 designates a tubular seal holder which, as shown in FIG. 14, has a pair of cut-out holes 23a, and which is disposed inside the inner periphery of the large-diameter portion 21a of the tubular cylinder 21. 24 denotes a nozzle tip of ceramic (see FIG. 15) which, as shown in FIG. 23, is integrally insert-molded to the right end of the nozzle portion 21c of the tubular cylinder 21. 25 denotes a filter case which receives a fibrous filter therein and prevents sample liquid sucked in a tip 45 (see FIG. 1) from being sucked into the nozzle tip 24, and the passage 21d of the nozzle portion 21c, etc. Even a small residue of sample liquid drawn and adhering therein would get mixed with and contaminates the next liquid which may be of a different type.

Please note that the tubular cylinder 21 may integrally be molded in advance with the tubular body 1 as a tubular housing.

With the above construction, since the nozzle tip 24 is made of ceramic, it has a high wear resistance, and has a high durability even if attachment thereto and detachment therefrom of a later-described tip 46 is repeated. Furthermore, since the nozzle tip 24 is formed on an outer peripheral surface thereof with an axially undulated uneven portion 24a, the frictional load between the nozzle tip 24 and the tip 46 is small, resulting in a smaller load when ejecting the tip 46 and easy ejecting operation.

Moreover, an expandable layer 36 of rubber or elastomer (see FIG. 23) is in advance first insert molded within one outer circumferential groove 24c on a to-be-insert-molded portion 24b of the nozzle tip 24 to the tubular cylinder 21, and thereafter this portion is second insert molded to the tubular cylinder 21. The reason for this is that, the pipette is heated to approximately 120° C. during autoclave for sterilization, and this causes the tubular cylinder 21 of resin to expand greater than the nozzle tip 24 of ceramic, there is a possibility to give rise to a clearance between them and to thereby weaken the force of the molded portion 24b to be assembled. To avoid this, the above expandable layer 36 is interposed between them so as to absorb and prevent the above clearance from taking place, and secure a strong force with which they are assembled to each other.

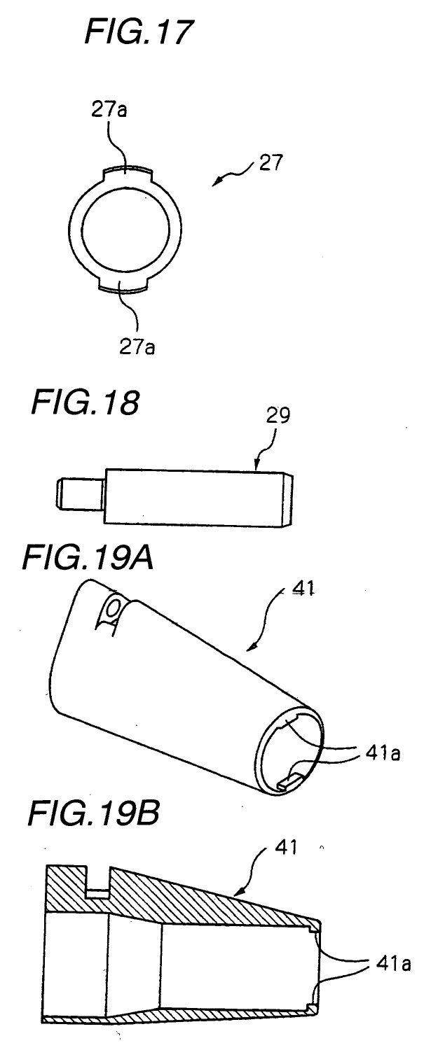

Next, 26 denotes a tubular plunger head which, as shown in FIG. 16, has left and right hole portions 26a, 26b and a pair of axially-extending recesses 26c. This plunger head 26 is disposed in the inner periphery of the tubular seal holder 23 with a ring-shaped second-stage spring holder 27 (see FIG. 17) interposed therebetween, and the left (upper) hole portion 26a receives the large-diameter portion 7a of the central shaft 7 therein with a plunger head spring 28 interposed and with the pair of protrusions 7d of the central shaft 7 engaged in the pair of axially-extending grooves 26c. Besides, inside the right (lower) hole portion 26b is press-fitted the plunger 29 (see FIG. 18). A pair of ear portions 27a of the second-stage spring holder 27 are engaged in the pair of cut-out holes 23a (see FIG. 14) of the tubular seal holder 23 and urged upward in FIG. 1 by the second-stage spring 30 to abut against the upper edges of the cut-out holes 23a.

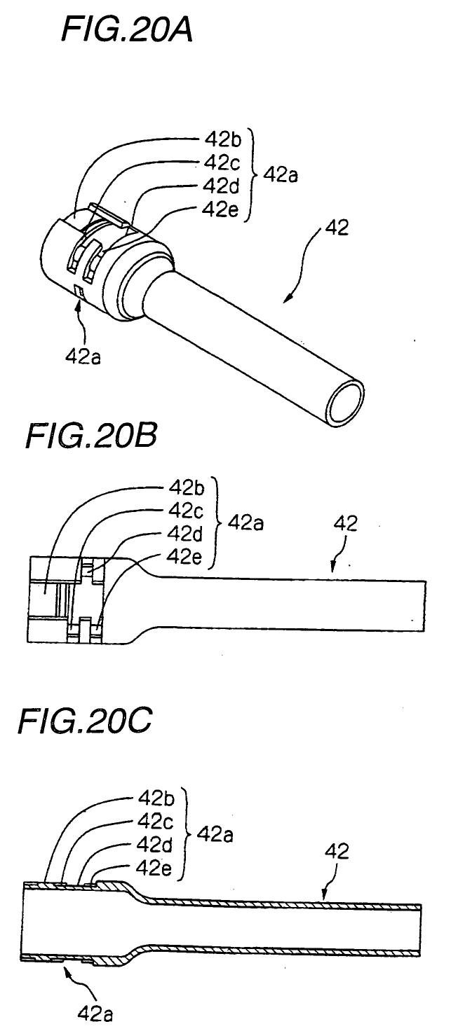

32 denotes an ejector mechanism which, as shown in FIG. 1, is substantially made up of an ejector button 33, an ejector shaft 34, an ejector lock 35, an upper ejector pipe 41, and a lower ejector pipe 42. The ejector shaft 34 is passed through a hole 52a of a counter plate 52 and a hole 2b of the central partition wall 2 (see FIG. 21), which are described later. The upper ejector pipe 41, as shown in FIG. 19, has a pair of engagement projections 41a on the inner periphery at the lower end. The lower ejector pipe 42, as shown in FIG. 20, has a pair of groove portions 42a on the outer periphery, and each outer peripheral groove portion 42a has a guide groove 42b and three engagement recessed portions 42c, 42d and 42e. Please note that in FIG. 1, 43 designates an ejector spring, 44 an ejector spring holder, and 45 an ejector cushion.

Consequently, as the lower ejector pipe 42 is inserted in the lower end of the upper ejector pipe 41, the engagement projections 41a of the latter are engagedly inserted into the outer peripheral groove portions 42a through guide grooves 42b, and then by turning the former relative to the latter by a predetermined angle, the engagement projections 41a are engaged in one of the three engagement recessed portions 42c, 42d and 42e, so that the axial (vertical) position of the former relative to the latter is variably fixed. In other words, engagement of the engagement projections 41a in the uppermost engagement recessed portions 42c allows the lower ejector pipe 42 to extend downward by the maximum length, while the engagement in the lowermost engagement recessed portions 42e provides for the minimum downwardly-extending length, and the engagement in the intermediate engagement recessed portions 42d provides for an intermediate downwardly-extending length. Owing to this, if tips 46 (see FIG. 1) of various standardized sizes are attached to the outer periphery of the nozzle tip 24, because the downwardly-extending length of the lower ejector pipe 42 may be adjusted in accordance therewith, a widened applicability can be obtained. Please note that in FIG. 1, because the engagement projections 41a are engaged in the intermediate engagement recessed portions 42d, the downwardly-extending length of the lower ejector pipe 42 is at an intermediate level.

Although in the above embodiment one first engagement portion 41a of the upper ejector pipe 41 is switchably engaged in one of the plurality of second engagement portions 42c, 42d and 42e of the lower ejector pipe 42, it may conversely be arranged such that one engagement portion on the lower ejector pipe 42 is switchably engaged in one of a plurality of engagement portions on the upper ejector pipe 41. Moreover, the plurality of engagement portions are not limited to three in number, and may be provided in two or four or more.

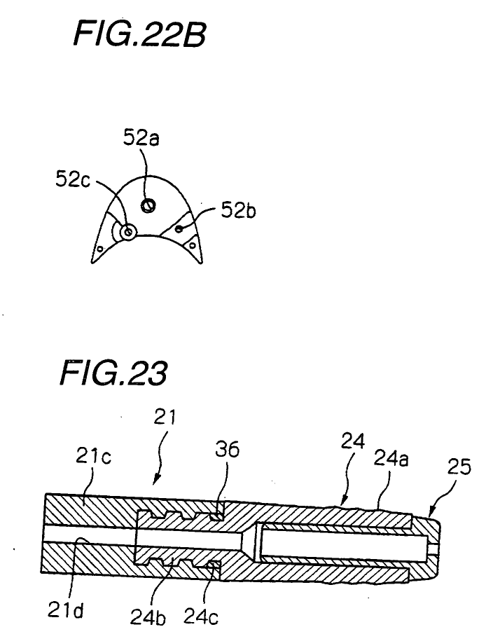

51 denotes a counter mechanism which, as shown in FIG. 21, is substantially made up of a drive drum 54 and three driven drums 55, which are fitted over a counter sleeve 53 which in turn is fitted to an ejector shaft 34, three ganged pinions 57 fitted over a pinion shaft 56 (the pinion shaft being passed between a hole 2c in the central partition wall 2 and a hole 52b in the counter plate 52), and one transmission gear 59 fitted over a transmission gear shaft 58 (the gear shaft being passed between a hole 2d in the central partition wall 2 and a hole 52c in the counter plate 52), all of which are located between the central partition wall 2 and the counter plate 52 (see FIG. 22). A small-diameter pinion 59a of the transmission gear 59 meshes with the outer circumferential gear portion 4a of the volume variably setting and calibration pipe 4, and a large-diameter gear 59b thereof meshes with a pinion 54a of the drive drum 54. The first ganged pinion 57 commonly meshes with both partial teeth 54b of the drive drum 54 and a gear 55a of the first driven drum 55, and the second and third ganged pinions 57 similarly commonly mesh with both the partial teeth 55b and the gears 55a of the second and third driven drums 55, respectively. In this case, each of the four drums 54 and 55 in total has ten numerals from “1 to 0” affixed on its outer periphery at positions equally spaced in the circumferential direction so as to numerically indicate the suction value in a four-digit number as a whole. 60 denotes a click spring (see FIG. 21) which is fixed in a recessed portion 52d of the counter plate 52 with screws 61, and a click projection 60a thereof switchably engages a selected one of the ten click recesses 54c disposed at equal spacings in the circumferential direction of the drive drum 54 so as to perform the positioning of the drive drum 54 in the rotational direction.

Consequently, if the volume variably setting and calibration pipe 4 is manually rotated in, for example, a clockwise direction as viewed from above, the transmission gear 59, which meshes with the outer circumferential gear portion 4a of the pipe 4, rotates in the direction of an arrow A in FIG. 21, thereby causing the drive drum 54 to rotate in the direction of an arrow B, so that the driven drums 55 are subsequently sequentially rotated in a carrying manner through meshing engagement between each partial teeth 54b, 55b and the corresponding ganged pinion 57, and a decreased numerical value of the suction volume is indicated. If the volume variably setting and calibration pipe 4 is conversely rotated in a counterclockwise direction, the suction volume numerical value is indicated increased.

Next, the operation of the above pipette will be described.

First, by grasping the pipette with a hand and pushing down the button 6 with the thumb, the central shaft 7, tubular plunger head 26 and plunger 29, which are apparently unitary, slide downward against the first-stage spring 10 through the first-stage stroke L1 until the flange portion 7c of the central shaft 7 abuts against the second-stage spring holder 27 (see FIGS. 1 and 2). With the pipette in this state, the tip 46 is immersed in a sample liquid.

If at this point the above pushing-down force is released, the central shaft 7 and the plunger 29 are returned upwardly by the first-stage spring 10 into the state of FIG. 1 where the stopper step portion 7b of the central shaft 7 abuts against the flange portion 5a of the stroke screw 5. Concurrently with this, a predetermined amount of the sample liquid is drawn into the tip 46.

Next, the distal end of the tip 46 is inserted into another container, and the push button 6 is again pushed down. Then, the plunger 29 again moves downward by the first-stage stroke L1 to the position of FIG. 2 in the same manner as mentioned above, whereby the sample is discharged from inside the tip 46 to the container by this first-stage discharge.

If the push button 6 is further pushed down beyond the position of FIG. 2, then the central shaft 7 and the plunger 29 slide downward through a second-stage stroke L2 (see FIGS. 2 and 3) against the first-stage spring 10 plus the second-stage spring 30 until the ear portions 27a of the second-stage spring holder 27 abut against the lower edge of the cut-out holes 23a of the seal holder 23. By this second-stage discharge, the sample, if any is remaining inside the tip 46 upon completion of the first-stage discharge, is completely discharged. Thus, an error in volume between the sucked and discharged can be eliminated, making it possible to accurately and reliably transfer a predetermined amount of a sample.

Next, as to the varying operation of the suction volume of a sample, as described above, as the volume variably setting and calibration pipe 4 is rotated in, for example, a clockwise direction as viewed from above, the clutch pipe 3 and the stroke screw 5 rotate in the same direction as one unit, whereby the stroke screw 5 (central shaft 7) moves downward in FIG. 1 so as to variably set the numerical value of the first-stage stroke L1 (suction volume) at a smaller one. If the pipe 4 is conversely rotated in a counterclockwise direction, the numerical value of the first-stage stroke L1 is variably set at a larger one. Please note that, at the same time as this variable setting of the suction volume, a numerical value corresponding to the above variably set volume is variably indicated through the meshing engagement between the outer circumferential gear portion 4a and the pinion portion 59a of the transmission gear 59 (see FIG. 21).

According to the construction as mentioned above, the first-stage spring 10 is disposed not below, but above the stroke screw 5, between the pushbutton 6 and the stroke screw 5. Hence, because the first-stage spring 10 moves vertically with its entire length maintained constant during the above suction volume variably setting operation, the first-stage spring 10 load once initially set remains as it is during the movement. Accordingly, because no compression of the first-stage spring 10 takes place even when, for example, the suction volume is set smaller, an increase in the first-stage spring 10 load, and thus a change in the button operation load are precluded. In contrast, in the conventional example, because the first-stage spring is located below the member corresponding to the stroke screw, the first-stage spring per se is compressed during the volume variably setting operation, unfavorably resulting in an increase in the spring load and a change in the button operation load.

Next, the way of variably setting the initial load of the first-stage spring 10 will be described. In FIG. 1, the first-stage spring load varying pipe 8 is rotated in a clockwise direction relative to the pushbutton 6. Then, through the thread engagement between the internal circumferential thread 8a of the pipe 8 and the external circumferential thread 9a of the first-stage spring extension setting plate 9, the first-stage spring extension setting plate 9 moves downward in the figure along the axially-extending guide slits 6b of the pushbutton 6 (see FIG. 9) and compresses the first-stage spring 10 by an amount corresponding to the movement, so that the initial load is set at a great level. If the first-stage spring load varying pipe 8 is rotated in the reverse direction, the initial load can be set at a small level. Owing to this, by suitably varying the initial load of the first-stage spring 10, the feeling (heaviness) with which the pushbutton 6 is pushed down can be adjusted.

Next, the way of calibrating an indication itself of a numerical value of the volume on the counter of the counter mechanism 51 in a case where said indication itself goes wrong will be described.

In FIG. 1, the volume variably setting and calibration pipe 4 is pulled upward by a distance m against the pipe holding spring 13. This releases the clutch engagement between the clutch claws 4b of the variably setting pipe 4 and the meshing gear portion 3a of the clutch pipe 3, but the meshing engagement between the outer circumferential gear portion 4a of the variably setting pipe 4 and the pinion portion 59a of the transmission gear 59 is still maintained as it is for the relatively large axial length of the gear. Accordingly, by further rotating the variably setting pipe 4 in, for example, a clockwise direction as viewed from above, the drums 54 and 55 are rotated via the transmission gear 59 so that the calibration is performed to lessen the indicated numerical value, while the clutch pipe 3 and the stroke screw 5, due to the above clutch disengagement, are not rotated and the actual volume of the cylinder chamber 21b remain unvaried. Furthermore, rotation of the variably setting pipe 4 in the reverse direction allows the indicated numerical value to be calibrated to a larger one. In this way, calibration can easily be done without needing a calibration-purpose jig or the like.

Next, the ejecting operation of a tip 46 with the ejector mechanism 32 will be described. In order to remove the tip 46 on completion of discharge of the sample, the ejector button 33 is pushed down in FIG. 1 with a thumb. Then, via the ejector shaft 34 and the upper ejector pipe 41, the lower ejector pipe 42 quickly slides downward against the ejector spring 43. Consequently, the lower end of the lower ejector pipe 42 comes to contact the tip 46 to press the same downward and quickly off from the nozzle tip 24. The nozzle tip 24 is now ready for the next tip 46 to be attached thereto. There is a case, however, where a tip 46 is unsuccessfully ejected, resulting from the different size type of the tip 46 which makes a change in the upper end position of the tip when the tip is attached to the nozzle tip 24.

To cope with this, the vertical position of the lower ejector pipe 42 is variably settable. To move the lower ejector pipe 42 to a position further lower than that in FIG. 1, the lower ejector pipe 42 is first rotated to disengage the intermediate engagement recessed portion 42d from the engagement projections 41a of the upper ejector pipe 41 (see FIGS. 19 and 20), pulled and moved downward, and then rotated again in the same direction to bring the uppermost engagement recessed portion 42c into engagement with the engagement projections 41a, so as to complete the setting to the lower position. Likewise, if the lower ejector pipe 42 is pushed and moved upward, and its lowermost engagement recessed portion 42e is engaged with the engagement projections 41a, the setting to an upper position is completed. This provides for the attachment of differently sized tips 46.

Incidentally, in the above embodiment, in order to variably set the suction volume with the volume variably setting and calibration pipe 4, it is arranged such that the rotation of the pipe 4 in either direction causes the clutch pipe 3 and the stroke screw 5 to rotate in the same direction as one unit, so as to move the stroke screw 5 vertically and variably set the suction volume. It is to be noted, however, that if the purpose is merely to variably set the suction volume, the clutch pipe 3 is not necessarily needed, and an arrangement in which the pipe 4 rotates directly together with the stroke screw 5 as one unit may be employed.

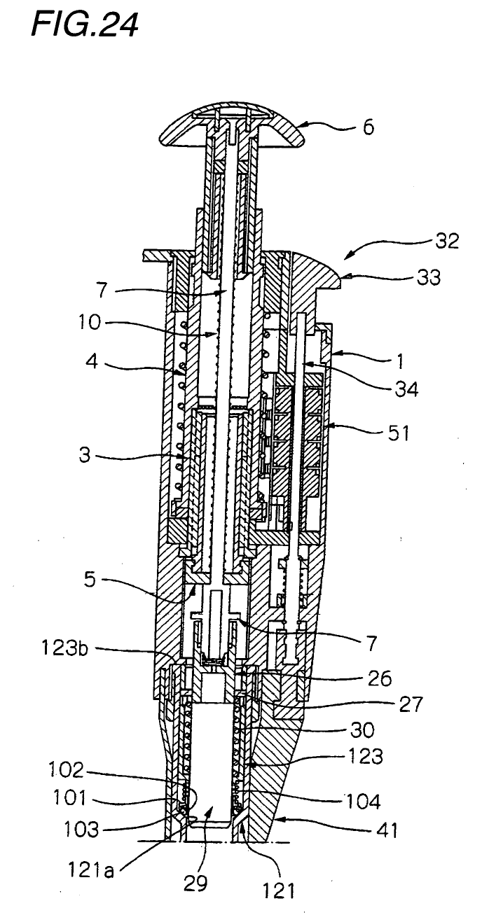

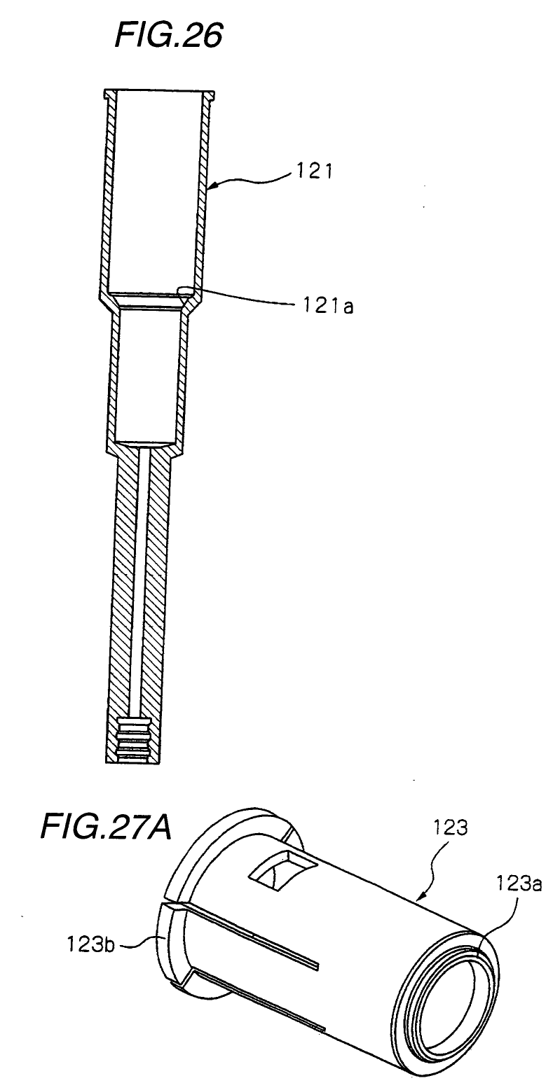

A second embodiment of a pipette according to the present invention will now be described with reference to FIGS. 24 to 32. In these figures, the same parts as in FIGS. 1 to 23 are given the same reference characters, and their description will be omitted. This second embodiment in particular has a feature in a plunger sealing mechanism provided between the plunger 29 and a tubular cylinder 121 inside which the plunger 29 is slidably fitted.

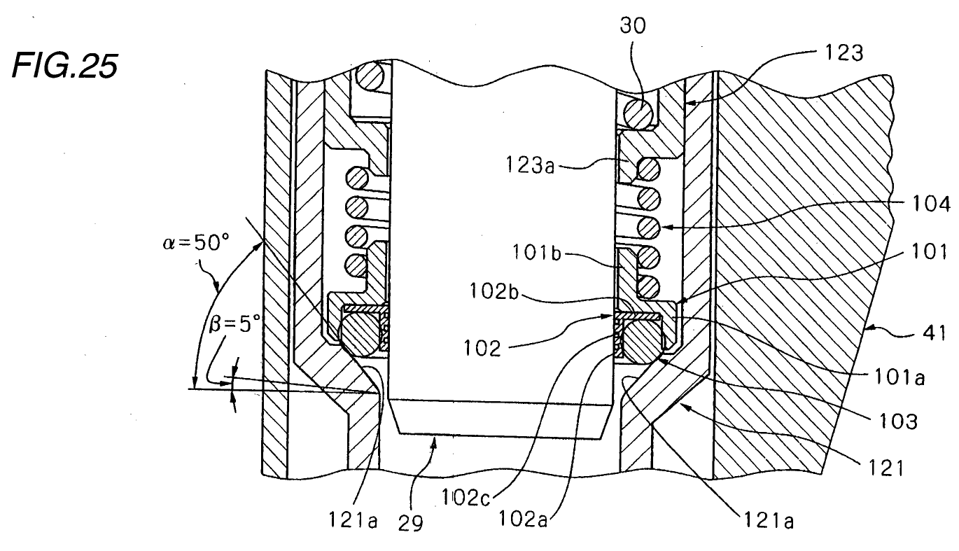

The plunger sealing mechanism, as shown in FIGS. 24 and 25, is made up of an O-ring retention ring 101 fitted around the plunger 29, a seal ring 102 fitted around the plunger 29, an O-ring 103 interposed between the O-ring retention ring 101 and the seal ring 102, and an O-ring pressing spring 104 which axially presses the O-ring retention ring 101 with a predetermined force to press the O-ring 103 against an inclined inner surface 121a of the tubular cylinder member 121 so that the seal ring 102 is radially inwardly pressed against the outer periphery of the plunger 29 by the component of the predetermined force that is in a direction perpendicular to the axis of the pipette. In this case, the inclination angle α (see FIGS. 25 and 32) of the inclined inner surface 12 is 40° to 65°, and preferably 50° relative to the direction perpendicular to the pipette axis, as will be described later.

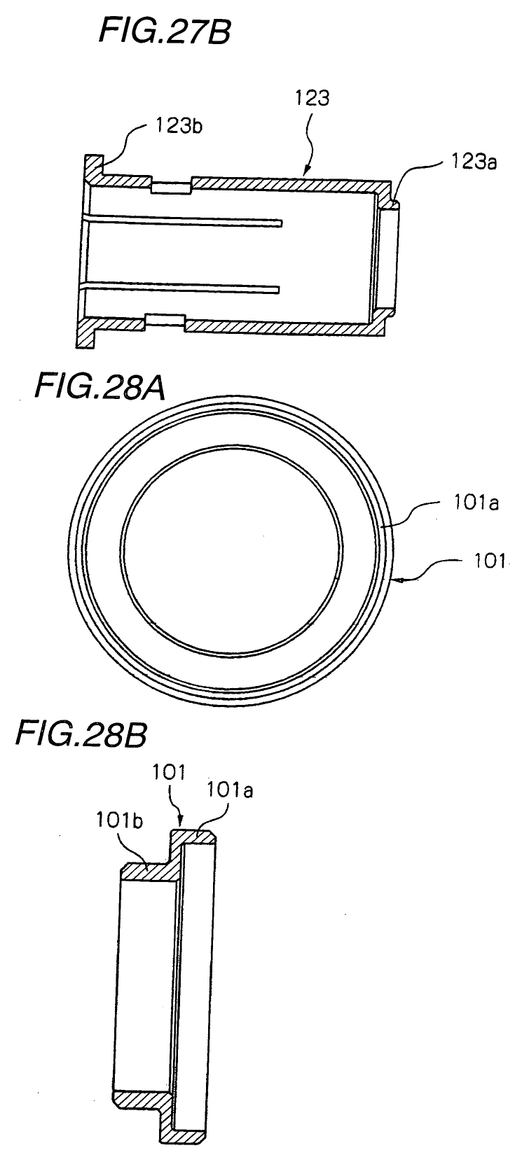

Furthermore, in the case of the second embodiment, the tubular seal holder 123 itself is slightly different in construction from the tubular seal holder 23 of the first embodiment in that it, as shown in FIGS. 27A and 27B, is provided at the lower end with a spring receiving portion 123a and at an upper end with a flange portion 123b. The upper-end flange portion 123b, as shown in FIG. 24, is held between the tubular body 1 and the upper end of the tubular cylinder 121 and, as a result, positions the tubular seal holder 123 in a fixed manner relative to the tubular body 1.

The O-ring retention ring 101, as shown in FIG. 28, has an O-ring holding portion 110a and a spring receiving portion 101b.

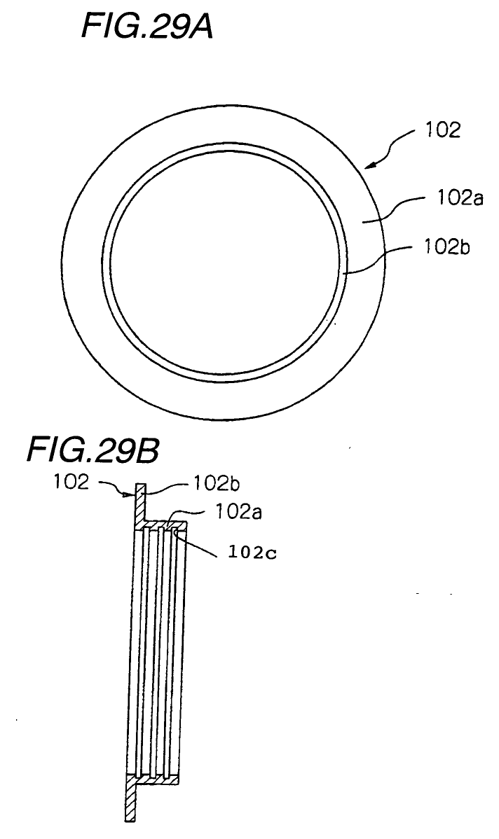

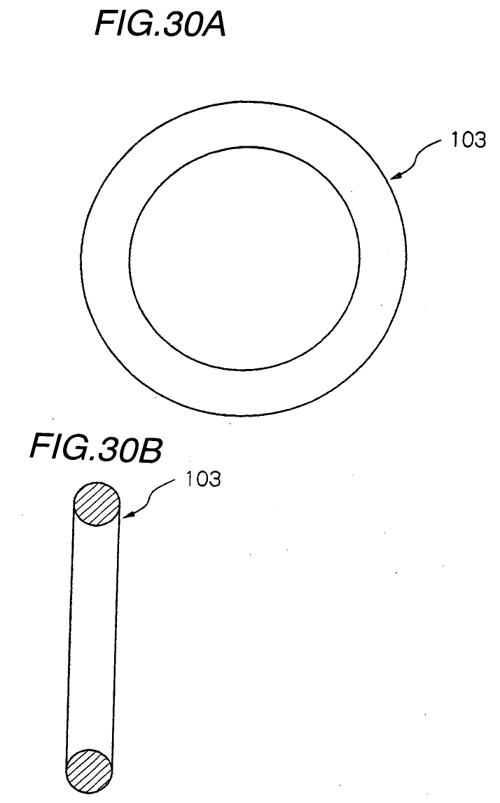

The seal ring 102, as shown in FIGS. 29A and 29B, has a ring-shaped seal portion 102a, a flange-like O-ring receiving portion 102b, and three inner circumferential grooves 102c provided on the inner peripheral surface of the seal portion 102a. Of these, the inner circumferential grooves 102c may not necessarily be provided, or may be provided in one, two or four or more instead of three. As shown in FIG. 25, in the state where this seal ring 102 is received inside the O-ring holding portion 110a of the O-ring retention ring 101, the O-ring 103 (see FIGS. 30A and 30B) is received between the O-ring holding portion 110a and the seal portion 102a. Please note that the material for the seal ring 102 is, for example, PTFE (trademark name: Teflon) which has a small frictional resistance and a high resistance to wear, or may be PTFE with glass fiber or carbon fiber mixed therein so as to have an improved resistance to wear.

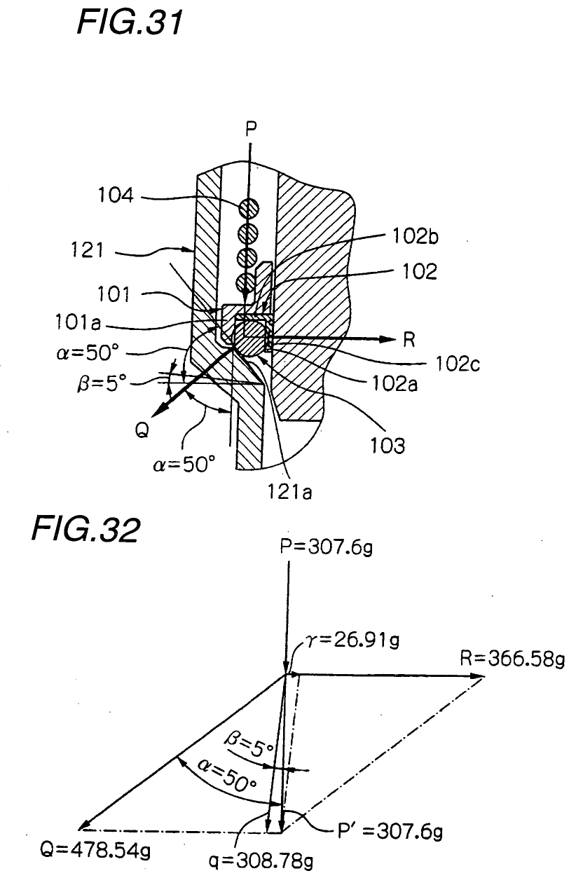

The O-ring pressing spring 104, as shown in FIG. 25, is interposed between the spring receiving portion 123a of the tubular seal holder 123 and the spring receiving portion 101b of the O-ring retention ring 101, and presses the O-ring 103 against the inclined inner surface 121a of the tubular cylinder 121 with an axial (downward) force P (see FIGS. 31 and 32) via the O-ring retention ring 101 and the seal ring 102.

Consequently, in FIG. 31, as the O-ring 103 is pressed against the inclined inner surface 121a, two components of the above axial (downward) force P, i.e., the component Q that is perpendicular to the inclined inner surface 121a and the component R that is in a direction perpendicular to the pipette axis are generated, which are shown as vectors in FIG. 32. In other words, in FIG. 32, the components obtained by moving the force P to the position of the force P′ and decomposing the same as a parallelogram are Q and R. In this case, by way of example, if the force P (P′) is 307.6 g, the values for the components Q and R, when the angle α is 50°, are 478.54 g and 366.58 g, respectively.

Also shown in FIGS. 31 and 32 is the angle of an inner surface (not shown) of a conventional tubular cylinder at the position corresponding to the inclined inner surface 121a of the tubular cylinder 121 of the second embodiment, which angle is, for example, β=5° (i.e., the inner surface almost coincides with the direction perpendicular to the pipette axis). In this case, assuming that the spring force of a second-stage spring 30 is the same force P (307.6 g) as the force P of the above O-ring pressing spring 104, the decomposed components q and r are 308.78 g and 26.91 g, respectively.

Thus, as is apparent from FIG. 32, where the inclination angle α=50° is employed for the inclined inner surface 121a of the tubular cylinder 121 of the second embodiment, the component R in the direction perpendicular to the axis (i.e., the force with which to press the ring shaped seal portion 102a) is considerably large (R=366.58 g>>r=26.91 g) as compared with the corresponding component r in the direction perpendicular to the axis in the case of the conventional example (β=5°), and it can be seen that the seal portion 102a is pressed against the outer peripheral surface of the plunger 29 with a large force.

Next, the operation of the above plunger sealing mechanism will be described. First, in FIGS. 25, 31 and 32, when the plunger 29 is vertically moved, the seal portion 102a of the seal ring 102 is deformed radially inwardly, i.e., in a diameter-reducing direction and pressed against the outer peripheral surface of the plunger 29 by the force R in the direction perpendicular to the axis which is based on the axial spring force P of the O-ring pressing spring 104. Hence, it can be seen that a good seal is provided around the outer peripheral surface of the plunger 29 by both the sealing portion of the seal ring 102 and at the portion where the O-ring 103 is pressed into contact with the inclined inner surface 121a of the tubular cylinder 121. Thus, even if a wear occurs in the sliding portions by a repeated use, a good hermeticity is maintained so that a reduction in the dispensing accuracy due to leakage of liquid from below to above the sealing portion is precluded, and a good dispensing accuracy is maintained.

In this case, owing to the plurality of inner circumferential grooves 102c present on the seal portion 102a of the seal ring 102, in the first place, although the frictional resistance to sliding of the plunger 29 tends to become greater as the force R in the direction perpendicular to the axis increases, the intimately contacting surface area can be reduced by the above inner circumferential grooves 102c so as to suppress a rise in the frictional resistance to the sliding. Second, if the seal portion 102a and the plunger 29 are worn down by sliding friction and wear powder is generated, the inner circumferential grooves 102c receives such a wear powder therein, so that further progress of wear which would otherwise be caused by the abrasive effect of the wear powder present between the sliding surfaces will be prevented. Incidentally, the inner circumferential grooves 102c are capable of receiving all wear powder generated during the later-described number of times of strokes of approximately 600,000 without overflow of the wear powder.

Next, the values for accuracy specifications (A) and repeatability specifications (B) which are obtained for each case where different angles α and β are formed by the inclined inner surface 121a of the above tubular cylinder 121 of the pipette and its correspondent, and the number of times by which the plunger 29 is reciprocally slid relative to the tubular cylinder 121 (the number of strokes) are varied, are shown in Table 1.

TABLE 1

| | | β = 5° | | | | | | | | | |
|---|---|---|---|---|---|---|---|---|---|---|---|
| | | Conventional | | | | α = 40° | | α = 50° | | α = 65° | |
| Stroke | | example | | α = 30° | | 2nd embodiment | | 2nd embodiment | | 2nd embodiment | |
| durability | | set at | set at | set at | set at | set at | set at | set at | set at | set at | set at |
| testNumber of | | 100 μl | 1000 μl | 100 μl | 1000 μl | 100 μl | 1000 μl | 100 μl | 1000 μl | 100 μl | 1000 μl |
| strokes | | (%) | (%) | (%) | (%) | (%) | (%) | (%) | (%) | (%) | (%) |
| 0 times | Accuracy | −0.090 | 0.025 | 0.291 | 0.223 | −0.624 | −0.412 | −0.264 | 0.239 | −0.092 | 0.294 |
| | Repeatability | 0.253 | 0.108 | 0.316 | 0.131 | 0.288 | 0.108 | 0.252 | 0.024 | 0.438 | 0.055 |
| 50,000 times | Accuracy | — | — | 1.236 | 0.819 | — | — | −0.454 | 0.134 | — | — |
| | Repeatability | — | — | 0.238 | 0.047 | — | — | 0.229 | 0.036 | — | — |
| 80,000 times | Accuracy | — | — | 1.486 | 0.817 | — | — | — | — | — | — |
| | Repeatability | — | — | 0.186 | 0.070 | — | — | — | — | — | — |
| 100,000 times | Accuracy | 1.301 | 0.330 | — | — | — | — | 0.094 | 0.327 | — | — |
| | Repeatability | 0.265 | 0.036 | — | — | — | — | 0.264 | 0.082 | — | — |
| 200,000 times | Accuracy | −8.735 | −8.519 | — | — | — | — | — | — | — | — |
| | Repeatability | 0.632 | 0.230 | — | — | — | — | — | — | — | — |
| 600,000 times | Accuracy | — | — | — | — | −0.936 | 0.303 | 0.553 | 0.172 | 0.672 | 0.169 |
| | Repeatability | — | — | — | — | −0.441 | 0.108 | 0.226 | 0.112 | 0.367 | 0.085 |

Accuracy specs (A)
when set at 100 μl ±1.0%
when set at 1000 μl ±0.7%
repeatability specs (B)
when set at 100 μl <0.5%
When set at 1000 μl <0.2%

In Table 1, measurements were conducted for the two cases where the suction/discharge volumes of the pipette are 100 μl (0.1 cc) and 1000 μl (1 cc) for each of the angles of α and β. Moreover, as to the accuracy specifications (A), the acceptable limits of accuracy were ±1.0% when set at 100 μl, and ±0.7% when set at 1000 μl. As to the repeatability specifications (B), <0.5% was pass when set at 100 μl, and <0.2% was pass when set at 1000 μl. In Table 1, numerical values of fail are indicated by underlines. Simple bars in Table 1 indicate that no measurements were conducted. Here, the accuracy specifications (A=AC) and the repeatability specifications (B=CV) are given by the following equations, respectively.

$$\begin{matrix}A C = \frac{\overline{x} - set value}{set value} \times 100 & Equation 1 \\ CV = \frac{SD}{\overline{x}} \times 100 & Equation 2\end{matrix}$$

Here, the “x with upper bar” means an average value (μl) of the actually measured data values “x” (μl), and “set value” the set value (μl) which was set in advance by the counter of the pipette. “SD” means the standard deviation and is given by the following equation.

$${σ}_{n - 1} = \sqrt{\frac{{x}_{1}^{2} + {x}_{2}^{2} + {x}_{3}^{2} … {x}_{n}^{2} - {( {x}_{1} + {x}_{2} + {x}_{3} … {x}_{n} )}^{2} / n}{n - 1}} \qquad Equation 3$$

Here, n means the number of measurements.

According to Table 1 above, in the case of the conventional example (β=5°), at the number of strokes of 100,000 and the number of strokes of 200,000, owing to lack of a sealing force at the seal portion 102a of the seal ring 102, there was caused leakage of dispensed liquid, resulting in failure of the accuracy and/or repeatability. In the case of α=30°, a failure likewise occurred at the numbers of times of 50,000 and 80,000. However, in the case of α=40° of the second embodiment, both the accuracy and repeatability were pass at the number of times of 600,000. Likewise, with α=50°, the result was pass at the number of times of 50,000, 100,000 and 600,000. Furthermore, with α=65°, the result was also pass at the number of times of 600,000. Please note that no experimental data were collected for the case of α>65° for its impracticality. In other words, if α becomes greater than 65°, almost all the axial force P of the O-ring pressing spring 104 that acts on the O-ring 103 is converted to the force R in the direction perpendicular to the pipette axis (see FIGS. 31 and 32), so as to make the force R greater. As a result, the pushing force for sliding the plunger 29 would also become greater than necessary, making the operation difficult. Incidentally, if the above sealing portion can assure accuracy up to the number of times of 600,000, the practical service life as a maintenance free product will suffice.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A pipette comprising:
a tubular body (1) having a first threaded portion (1b);
a stroke screw (5) provided inside the body (1) and having a second threaded portion (5c), said second threaded portion threadingly engaging said first threaded portion (1b);
a volume variably setting member (4) disposed to be rotatable together with the stroke screw (5) as one unit and axially slidable relative thereto;
a central shaft (7) provided inside said tubular body (1), which is coupled to a plunger (29) and operable to be pushed down; and
a first-stage spring (10) interposed between an upper portion of said central shaft (7) and said stroke screw (5), said first-stage spring urging the central shaft (7) upward so that a predetermined portion (7b) thereof urgingly abuts against the stroke screw (5), wherein
by rotating said volume variably setting member (4) as appropriate, the stroke screw (5) is caused to rotate together therewith as one unit relative to the body (1) so that said stroke screw (5) and said central shaft (7) axially slide together as one unit apparently by a predetermined amount, thereby variably setting a suction volume of said pipette.

2. A pipette comprising:
a substantially tubular body (1) having a first threaded portion (1b);
a stroke screw (5) provided inside the body (1) and having a second threaded portion (5c), said second threaded portion threadingly engaging said first threaded portion (1b);
a clutch member (3) having a first engagement portion (3a) and disposed to be rotatable together with the stroke screw (5) as one unit and axially slidable relative thereto;
a volume variably setting member (4) having a second engagement portion (4b) and disposed to be rotatable together with the clutch member (3) as one unit when said first and second engagement portions (3a, 4b) are in engagement with each other;
a central shaft (7) provided inside said tubular body (1), which is coupled to a plunger (29) and operable to be pushed down; and
a first-stage spring (10) interposed between an upper portion of said central shaft (7) and said stroke screw (5), said first-stage spring urging the central shaft (7) upward so that a predetermined portion (7b) thereof urgingly abuts against the stroke screw (5), wherein
by rotating said volume variably setting member (4) as appropriate, the stroke screw (5) is caused to rotate together therewith as one unit relative to the body (1) so that said stroke screw (5) and said central shaft (7) axially slide together as one unit apparently by a predetermined amount, thereby variably setting a suction volume of said pipette.

3. A pipette comprising:
a substantially tubular body (1) having a first threaded portion (1b);
a stroke screw (5) provided inside the body (1) and having a second threaded portion (5c), said second threaded portion threadingly engaging said first threaded portion (1b);
a central shaft (7) provided inside said tubular body (1), which is coupled to a plunger (29) and operable to be pushed down;
a first-stage spring load varying member (8) having a third threaded portion (8a) and provided at an upper portion of said central shaft (7) to be rotatable relative thereto;
a first-stage spring extension setting member (9) having a fourth threaded portion (9a) which threadingly engages said third threaded portion (8a), and provided at the upper portion of said central shaft (7) to be unrotatable and axially slidable relative thereto; and
a first-stage spring (10) interposed between the upper portion of said central shaft (7) and said stroke screw (5), said first-stage spring urging said central shaft (7) upward so that a predetermined portion (7b) thereof urgingly abuts against the stroke screw (5), wherein
by rotating said first-stage spring load varying member (8) as appropriate, said first-stage spring extension setting member (9) is caused to axially slide relative to the body (1), thereby variably setting an entire extension length of said first-stage spring (10).

4. A pipette having a tubular housing (1 or 21) made of resin, wherein
a nozzle tip (24) made of ceramic is integrally insert-molded at a distal end portion of said tubular housing (1 or 21).

5. The pipette according to claim 4, wherein said nozzle tip (24) made of ceramic has an expandable layer (36) of rubber or elastomer insert-molded at a predetermined portion (24c) thereof prior to its insert-molding to said tubular housing (1 or 21).

6. The pipette according to claim 4, wherein said nozzle tip (24) made of ceramic has an uneven portion (24a) formed on an outer periphery thereof.

7. A pipette having a tubular body (1), wherein
material for said tubular body (1) is finely foamed molded material.

8. The pipette according to claim 7, wherein said finely foamed molded material is polyphenyl sulfone.

9. A pipette having an ejector mechanism for a tip, wherein
said ejector mechanism (32) includes at least an ejector button (33), an upper ejector pipe (41), and a lower ejector pipe (42) which pushes a tip (46), and wherein
a first engagement portion (41a) provided on either one of said upper ejector pipe (41) or said lower ejector pipe (42) is switchably engageable with any of a plurality of second engagement portions (42c, 42d, 42e) provided on the other so that a distal end position of said lower ejector pipe (42) is varied.

10. A pipette comprising:
a tubular body (1);
a stroke screw (5) provided inside said body (1), which variably sets a suction volume of the pipette;
a clutch member (3) having a first engagement portion (3a) and disposed to be rotatable together with the stroke screw (5) as one unit and axially slidable relative thereto;
a calibration member (4) having a second engagement portion (4b) and disposed to be axially slidable relative to the clutch member (3) and rotatable together therewith as one unit only when the first and second engagement portions (3a, 4b) are engaged with each other;
a central shaft (7) provided inside said tubular body (1), which is coupled to a plunger (29) and operable to be pushed down; and
a suction volume indicating counter mechanism (51) which is capable of interlocking with said calibration member (4), wherein
by axially sliding said calibration member (4) to release engagement of said first and second engagement portions (3a, 4b), and rotating said calibration member (4) in this state as appropriate, only said counter mechanism (51) is operated without causing any rotation of said stroke screw (5) so as to perform a calibration of an indication of a numerical value of the suction volume.

11. In a pipette in which a central shaft (7) is provided inside a tubular body (1) to be vertically slidable together with a plunger (29) as one unit and is adapted to be pushed down against at least a first-stage spring (10), a plunger sealing mechanism for the pipette which is provided between said plunger (29) and a tubular cylinder member (121) in which said plunger (29) is slidably fitted, said plunger sealing mechanism comprising:
an O-ring retention ring (101) fitted around said plunger (29);
a seal ring (102) fitted around said plunger (29);
an O-ring (103) interposed between said O-ring retention ring (101) and said seal ring (102); and
an O-ring pressing spring (104) which axially presses said O-ring retention ring (101) with a predetermined force to press said O-ring (103) against an inclined inner surface (121a) of said tubular cylinder member (121) so that said seal ring (102) is radially inwardly pressed against an outer peripheral surface of said plunger (29) by a component of said predetermined force that is in a direction perpendicular to the axis of the pipette, wherein
an inclination angle α of said inclined inner surface (121a) is 40° to 65° relative to the direction perpendicular to the axis of the pipette.

12. The plunger sealing mechanism for a pipette according to claim 11, wherein said inclination angle α of said inclined inner surface (121a) is 50° relative to the direction perpendicular to the axis of the pipette.

13. The plunger sealing mechanism for a pipette according to claim 11, wherein said seal ring (102) has one or more circumferential grooves (102c) on an inner peripheral surface of a sealing portion (102a) thereof which fits around the outer peripheral surface of said plunger (29).
